(19) United States
(12) Patent Application Publication
(10) Pub. No.: US 2013/0069435 A1
(43) Pub. Date: Mar. 21, 2013

(54) Pre-Stage Boost Device for UPS

(71) Applicants: Lunquan Li, Shenzhen (CN); Heming Li, Shenzhen (CN); Shuqin Zhuang, Shenzhen (CN); Feng He, Shenzhen (CN); Yilei Gu, Shenzhen (CN)

(72) Inventors: Lunquan Li, Shenzhen (CN); Heming Li, Shenzhen (CN); Shuqin Zhuang, Shenzhen (CN); Feng He, Shenzhen (CN); Yilei Gu, Shenzhen (CN)

(21) Appl. No.: 13/574,541

(22) PCT Filed: Jan. 25, 2011
(86) PCT No.: PCT/CN2011/070598

§ 371 Date: Dec. 3, 2012

(30) Foreign Application Priority Data
Jan. 26, 2010 (CN) 201010103696.2

(51) Int. Cl. H02J 9/04

(52) U.S. Cl. CPC H02J 9/04
USPC 307/66

(57) ABSTRACT

A pre-stage boost device, comprising: a selector switch (130); a power factor inductor (140), a common boost circuit (150), a rectifier circuit (160), and a filter circuit (170). The common boost circuit includes: connected in series a first switch (Q1), a second switch (Q2) and a third switch (Q3). The rectifier circuit includes two rectifier diodes (D5, D6). The filter circuit includes connected in series two capacitors (C1, C2). Maximum multiplexing of the main power components under the battery mode and the commercial power mode is achieved by this invention, the cost to performance ratio is also improved.

### TECHNICAL FIELD

This invention involves a pre-stage boost device for UPS.

### BACKGROUND TECHNOLOGY

In the currently available UPS power supplies, voltage boost of the commercial power, or power factor correction, are usually required in order to satisfy the rating requirements of the power factor and harmonic wave as well as the requirement of voltage conversion of post-stage convertors. When commercial power cannot meet the demands, battery power supply is needed. In this case, a direct boost of the battery voltage is also needed to supply post-stage conversions.

Thus, the topology of the pre-stage boost of UPS in the current technology can be divided into two scenarios. In the first, the commercial power boost circuit and the battery power boost circuit are separated; wherein under the commercial power mode only on inductor is required to achieve the boost of the positive and negative BUS, and the boost of the battery power relies on an entirely separate convertor. In the second, the commercial power boost circuit and the battery boost circuit are combined into one, but two inductors are needed for the commercial power boost and battery power boost to achieve the voltage boost of the positive and negative BUS. Furthermore, they can be divided into the two categories of single-battery setup and dual-battery setup. The problem of a poor multiplexing between the main power components exists in all circuits mentioned above, and the cost to performance ratio in the situation of medium or low power is also relatively poor.

### CONTENT OF THE INVENTION

Based on this, the present invention is aimed at finding a technical solution of providing an UPS pre-stage boost device that can maximally multiplex the main power components, and at the same time achieve a higher cost to performance ratio.

A pre-stage boost device for UPS is provided by this invention, the device comprises:

a selector switch, for the selection of connecting to AC power input or battery input;

a power factor inductor, one end thereof is coupled to the said selector switch;

a common boost circuit, including: coupled in sequence, a first switch, a second switch and a third switch;

wherein, one end of the said first switch and the other end of the said power factor inductor are coupled to a first node; one end of the said second switch and one end of the said third switch are coupled to a grounding node; and the other end of the said third switch and the anode of the battery input are coupled to a second node;

a rectifier circuit, including: one end thereof is coupled to the said first node, the other end is coupled to a rectifier diode of the positive output terminal of the said pre-stage boost device for UPS; one end thereof is coupled to the said first node, the other end is coupled to a rectifier diode of the negative output terminal of the said pre-stage boost device for UPS; and, one end is coupled to the negative output terminal of the said pre-stage boost device for PUS, the other end is coupled to a rectifier diode of the cathode of the said battery input. The said rectifier diode and rectifier diode are in opposite directions in relation to the said first node, and the anode of the said rectifier diode and the anode of the rectifier diode are coupled to each other; and

a filter circuit, including: one end thereof is coupled to the negative output terminal of the said pre-stage boost device for UPS, the other end is coupled to a first capacitor of the said grounding node; and, one end thereof is coupled to the said grounding node, the other end is coupled to a second capacitor of the negative output terminal of the said pre-stage boost device for UPS.

By utilizing the above-described technical solution, a shared use of the common boost circuit is ensured whether AC power input or the battery input is selected; namely, the pre-stage boost function of an UPS is achieved through the selective connection or disconnection of the first switch, the second switch and the third switch.

In order to further enhance the drive capability of the common boost circuit, furthermore:

A first diode is connected in parallel to the said first switch, a second diode is connected in parallel to the second switch, and a third diode is connected in parallel to the third switch. The said first diode and second diode are coupled to each other in opposite directions, and the said second diode and third diode are in opposite directions in relation to the said grounding node.

Wherein, for two diodes coupled to a same node, if they both point toward or point away from this node, then they are described as the two diodes are in the same direction in relation to this node; otherwise, they are described as in opposite directions in relation to this node.

Preferably, the first switch, second switch and third switch are a MOS tube respectively, or any other controllable switches.

A pre-stage boost device for UPS is also provided in this invention, comprising:

a selector switch, for the selection of connecting to AC power input or battery input;

a power factor inductor, one end thereof is coupled to the said selector switch;

a common boost circuit, including: closed-loop coupled in sequence, a rectifier diode, a rectifier diode, a second switch, and a third switch;

wherein, one end of the said rectifier diode, one end of the said rectifier diode and the other end of the said power factor inductor are all coupled to a first node; one end of the said second switch and one end of the said third switch are coupled to a grounding node; the other end of the said third switch, the other end of the rectifier diode and the cathode of battery input are coupled to a second node. The said rectifier diode and the said rectifier diode are in opposite directions in relation to the said first node;

a rectifier circuit, including: one end thereof is coupled to the said first node, the other end is coupled to a rectifier diode of the positive output terminal of the said pre-stage boost device for UPS; one end thereof is coupled to the said first node, the other end is coupled to a rectifier diode of the negative output terminal of the said pre-stage boost device for UPS; and, one end if coupled to the negative output terminal of the said pre-stage boost device for UPS, the other end is coupled to a rectifier diode of the cathode of the battery input. The said rectifier diode and rectifier diode are in opposite directions in relation to the said first node, and the anode of the said rectifier diode and the anode of the rectifier diode are coupled to each other; and

a filter circuit, including: one end thereof is coupled to the negative output terminal of the said pre-stage boost device for UPS, the other end is coupled to a first capacitor of the said grounding node; and, one end thereof is coupled to the said grounding node, the other end is coupled to a second capacitor of the negative output terminal of the said pre-stage boost device for UPS.

By utilizing the above-described technical solution, a shared use of the common boost circuit can be ensured whether AC power input or battery inputs is selected; namely the pre-stage boost function of an UPS is achieved through the selective connection or disconnection of the second switch and the third switch.

In order to further enhance the drive capability of the common boost circuit, furthermore:

A second diode is connected in parallel to the said second switch, and a third diode is connected in parallel to the third switch; the said first diode and the rectifier diode are coupled to each other in opposite directions, and the said second diode and third diode are in opposite directions in relation to the said grounding node.

Preferably, the said second switch and third switch is a MOS tube respectively, or any other controllable switches.

A pre-stage boost device for UPS is also provided in this invention, comprising:

a selector switch, for the selection of connecting to AC power input or battery input;

a power factor inductor, one end thereof is coupled to the said selector switch;

a common boost circuit, including: closed loop coupled in sequence, a rectifier diode, a second switch, a third switch, and a fourth switch;

wherein, one end of the said rectifier diode, one end of the said fourth switch, and the other end of the power factor inductor are all coupled to a first node, one end of the second switch and one end of the third switch are coupled to a grounding node, the other end of the said third switch, the other end of the said fourth switch and the cathode of battery input are coupled to a second node;

a rectifier circuit, including: one end thereof is coupled to the said first node, the other end is coupled to a rectifier diode at the positive output terminal of the said pre-stage boost device for UPS; one end thereof is coupled to the said first node, the other end is coupled to a rectifier diode at the negative output terminal of the pre-stage boost device for UPS; and, one end is coupled to a rectifier diode of the negative output terminal of the said pre-stage boost device for UPS, the other end is coupled to a rectifier diode of the cathode of the battery input. The said rectifier diode and rectifier diode are in opposite directions in relation to the said first node, and the anode of the said rectifier diode and the anode of the rectifier diode are coupled to each other; and,

a filter circuit, including: one end thereof is coupled to the negative output terminal of the said pre-stage boost device for UPS, the other end is coupled to a first capacitor of the said grounding node; and, one end thereof is coupled to the said grounding node, the other end is coupled to a second capacitor of the negative output terminal of the said pre-stage boost device for UPS.

By utilizing the above-described technical solution, a shared use of the common boost circuit is ensured whether AC power input or battery input is selected; namely, the pre-stage boost function of an UPS is achieved through the selective connection and disconnection of the second, the third and the fourth switches.

In order to further enhance the drive capacity of the common boost circuit, furthermore:

A second diode is connected in parallel to the said second switch, a third diode is connected in parallel to the third switch, and a fourth diode is connected in parallel to the fourth switch. The said first diode and the rectifier diode are coupled to each other in opposite directions, the said second diode and the third diode are in opposite directions in relation to the said grounding node, and the said rectifier diode and the said fourth diode are in opposite directions in relation to the said first node.

Preferably, the said second, third and fourth switch is a MOS tube respectively, or any other controllable switch.

A pre-stage boost device for UPS is also provided in this invention, comprising:

a selector switch, for the selection of connecting to AC power input or battery input;

a power factor inductor, one end thereof is coupled to the said selector switch;

a common boost circuit, including: closed loop coupled in sequence; a first switch, a second switch, a third switch and a fourth switch;

wherein, one end of the said first switch, one end of the said fourth switch and the other end of the said power factor inductor are all coupled to a first node, one end of the said second switch and one end of the third switch are coupled to a grounding node, the other end of the said third switch, the other end of the said fourth switch and the cathode of battery input are coupled to a second node;

a rectifier circuit, including: one end thereof is coupled to the said first node, the other end is coupled to a rectifier diode of the positive output terminal of the said pre-stage boost device for UPS; one end thereof is coupled to the said first node, the other end is coupled to a rectifier diode of the negative output terminal of the said pre-stage boost device for UPS; and, one end is coupled to negative output terminal of the said pre-stage boost device for UPS, the other end is coupled to a rectifier diode of the cathode of battery input. The said rectifier diode and rectifier diode are in opposite directions in relation to the said first node, and the anode of the said rectifier diode and the anode of the rectifier diode are coupled to each other; and

a filter circuit, including: one end thereof is coupled to the negative output terminal of the said pre-stage boost device for UPS, the other end is coupled to a first capacitor of the said grounding node; and, one end is coupled to the said grounding node, the other end is coupled to a second capacitor of the negative output terminal of the said pre-stage boost device for UPS.

By utilizing the above-described technical solution, a shared use of the common boost circuit can be ensure whether AC power input or battery input is selected; namely, the pre-stage boost function of an UPS is achieved through the selective connection or disconnection of the first switch, the said second, third and fourth switches.

In order to further enhance the drive capacity of the common boost circuit, furthermore:

A first diode is connected in parallel to the said first switch, a second diode is connected in parallel to the said second switch, a third diode is connected in parallel to the third switch, and a fourth diode is connected in parallel to the said fourth switch. The said first diode and the said second diode are coupled to each other in opposite directions, the said second diode and third diode are in opposite directions in relation to the said grounding node, and the said first diode and the said fourth diode are in opposite directions in relation to the said first node.

Preferably, the said first, second, third and fourth switch is a MOS tube respectively, or any other controllable switch.

In the above mentioned four technical solutions of this invention, the connections of the common boost circuit to the external other circuits are the same. Moreover, in the further improved embodiments, a switch component with diodes connected in parallel is used inside all the common boost circuits; thus achieving the multiplexing of this circuit under AC or DC mode via the control of the switches.

Compared with the currently available technology, the present invention has the advantage of maximally multiplexing the main power components of battery mode and the commercial power mode, and at the same time a higher cost to performance ratio is also gained.

### DESCRIPTIONS OF THE DRAWINGS

FIG. 1 is a structural diagram of a working mode of the first embodiment of this invention.

FIG. 2 is a structural diagram of another working mode of the first embodiment of this invention.

FIG. 3 is a structural diagram of a working mode of the second embodiment of this invention.

FIG. 4 is a structural diagram of another working mode of the second embodiment of this invention.

FIG. 5 is a structural diagram of a working mode of the third embodiment of this invention.

FIG. 6 is a structural diagram of another working mode of the third embodiment of this invention.

FIG. 7 is a structural diagram of a working mode of the fourth embodiment of this invention.

FIG. 8 is a structural diagram of another working mode of the fourth embodiment of this invention.

### DETAILED EMBODIMENTS

The present invention is further explained with reference to drawings and better embodiments.

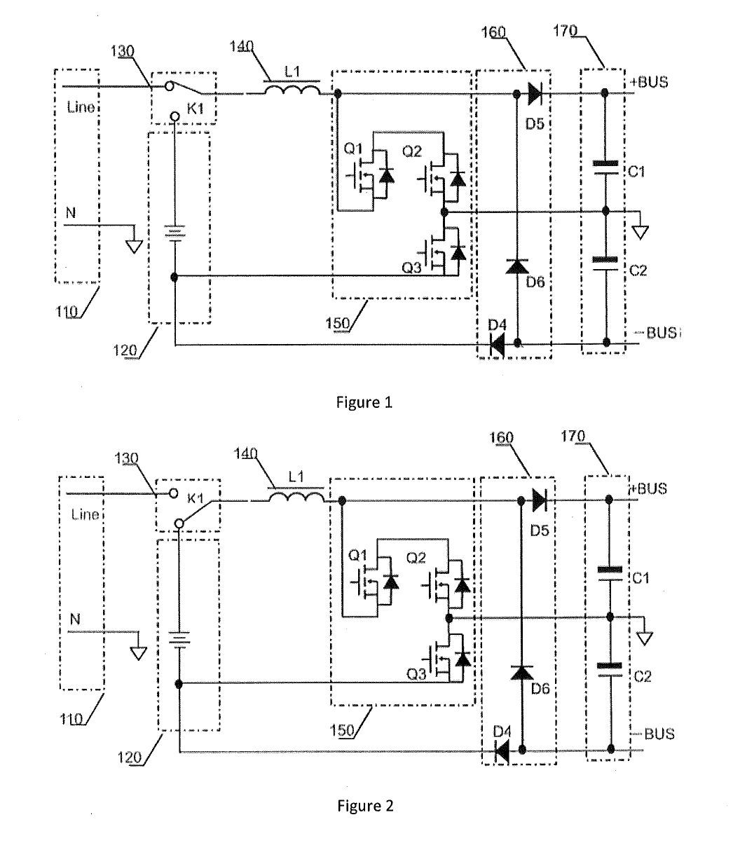

FIGS. 1 and 2 depict the structures of an embodiment of this invention under different work status. A pre-stage boost device for UPS, comprising the following components:

a selector switch 130 of a single-pole, double-throw switch;

a power factor inductor 140, with its one end coupled to the said selector switch 130;

a common boost circuit 150, including: coupled in sequence, a first switch Q1 with a first diode connected in parallel thereto, a second switch Q2 with a second diode connected in parallel thereto, and, a third switch Q3 with a third diode connected in parallel thereto;

a rectifier circuit 160, including: one end thereof is connected to the said first node, the other end is coupled to a rectifier diode D5 of the positive output terminal of the said pre-stage boost device for UPS; one end thereof is coupled to the said first node, the other end is coupled to a rectifier diode D6 of the negative output terminal of the said pre-stage boost device for UPS; and, one end is coupled to the negative output terminal of the said pre-stage boost device for UPS, and the other end is coupled to a rectifier diode D4 of the cathode of the battery input 120. The said rectifier diode D5 and rectifier diode D6 are in opposite directions in relation to the said first node, the anode of the said rectifier diode D4 and the anode of rectifier diode D6 are coupled to each other; and

a filter circuit 170, including: one end thereof is coupled to the negative output terminal of the said pre-stage boost device for UPS, the other end is coupled to a first capacitor C1 of the said grounding node; and, one end thereof is coupled to the said grounding node and the other end is coupled to a second capacitor C2 at the negative output of the said pre-stage boost device for UPS.

Wherein, the first switch Q1, the second switch Q2 and the third switch Q3 are a MOS tube respectively.

Referred to FIG. 2, DC supply from battery input 120 is selected for the selector switch 130. The corresponding boost operation of this pre-stage boost device for UPS is achieved through the following mode.

When the first switch Q1, second switch Q2 and third switch Q3 are all closed, the power factor inductor 140 is charged from the battery input 120.

When the second switch Q2 and the third switch Q3 are disconnected, the first capacitor C1 and the second capacitor C2 in the filter circuit 170 are charged from the battery input 120 and the power factor inductor 140.

When the third switch Q3 is disconnected, and the first switch Q1 and second switch Q2 are closed, the second capacitor C2 in the filer circuit 170 is charged from the battery input 120 and the power factor inductor 140.

When the third switch Q3 is closed, and the first switch Q1 and second switch Q2 are disconnected, the first capacitor C1 in the filter circuit 170 is charged from the battery input 120 and the power factor inductor 140.

Referred to FIG. 1, AC supply of the AC power input 110 is selected for the selector switch 130. The corresponding boost operation of this pre-stage boost device for UPS is achieved through the following mode.

During the positive AC half cycle:

As long as the second switch Q2 is closed, the power factor inductor 140 is charged from the AC power input 110.

As long as the second switch Q2 is disconnected, the first capacitor C1 in the filter circuit 170 is charged from the AC power input and the power factor inductor 140.

During the negative AC half cycle:

As long as the first switch Q1 is closed, the power factor inductor 140 is charged from the AC power input 110.

As long as the second switch Q2 is disconnected, the second capacitor C2 in the filter circuit 170 is charged from the AC 110 power input and the power factor inductor 140.

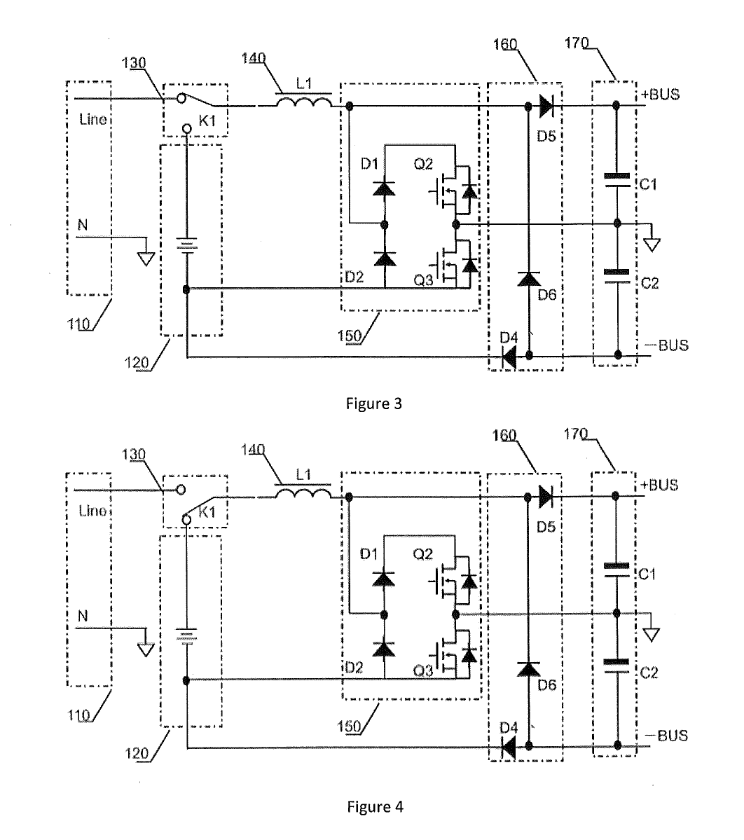

FIG. 3 and FIG. 4 show the structures of another embodiment of this invention under different work status. A pre-stage boost device for UPS, comprising:

a selector switch 130, for the selection of connecting to AC power input 110 or the battery input 120;

a power factor inductor 140, one end thereof is coupled to the said selector switch 130;

a common boost circuit 150, including: closed loop coupled in sequence, a rectifier diode D2, a rectifier diode D1, a second switch Q2 with a second diode connected thereto in parallel, and, a third switch Q3 with a third diode connected thereto in parallel;

a rectifier circuit 160, including: one end thereof is coupled to the said first node, the other end is coupled to a rectifier diode D5 of the positive output terminal of the said pre-stage boost device for UPS; one end thereof is coupled to the said first node, the other end is coupled to a rectifier diode D6 of the genitive output terminal of the said pre-stage boost device for UPS; and, one end is coupled to the negative output terminal of the said pre-stage boost device for UPS, the other end is coupled to a rectifier diode D4 of the cathode of the said battery input 120. The said rectifier diode D5 and rectifier diode D6 are in opposite directions in relation to the said first node, and the anode of the said rectifier diode D4 and the anode of rectifier diode D6 are couple to each other; and

a filter circuit 170, including: one end thereof is coupled to the negative output terminal of the said pre-stage boost device for UPS, the other end is coupled to a first capacitor C1 of the said grounding node; and, one end thereof is coupled to the said grounding node, the other end is coupled to a second capacitor C2 of the negative output terminal of the said pre-stage boost device for UPS.

Wherein, the said second switch Q2 and third switch Q3 are a MOS tube respectively.

Referred to FIG. 4, DC power supply from the battery input 120 is selected for the selector switch 130. The corresponding boost operation of this pre-stage boost device for UPS is achieved through the following mode.

When the second switch Q2 and the third switch Q3 are both closed, the power factor inductor 140 is charged from the battery input 120.

When the second switch Q2 and third switch Q3 are both disconnected, the first capacitor C1 and second capacitor C2 in the filer circuit 170 are charged from the battery input 120 and the power factor inductor 140.

When the second switch Q2 is closed, and the third switch Q3 is disconnected, the second capacitor C2 in the filer circuit 170 is charged from the battery input 120 and the power factor inductor 140.

When the second switch Q2 is disconnected, and the third switch Q3 is closed, the first capacitor C1 in the filer circuit 170 is charged from the battery input 120 and the power factor inductor 140.

Referred to FIG. 3, AC supply of the AC power input 110 is selected for the selector switch 130. The corresponding boost operation of this pre-stage boost device for UPS is achieved through the following mode.

During the positive AC half cycle:

As long as the second switch Q2 is closed, the power factor inductor 140 is charged from the AC power input 110.

As long as the second switch Q2 is disconnected, the first capacitor C1 in the filter circuit 170 is charged from the AC power input 110 and the power factor inductor 140.

During the negative AC half cycle:

As long as the third switch Q3 is closed, the power factor inductor 140 is charged from the AC power input 110.

As long as the third switch Q3 is disconnected, the second capacitor C2 in the filer circuit 170 is charged from the AC power input 110 and the power factor inductor 140.

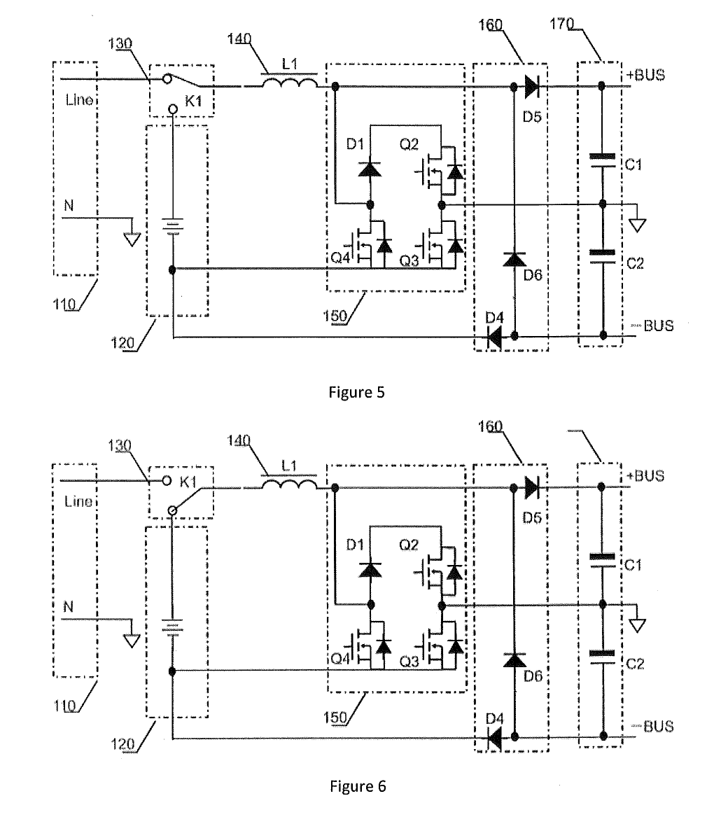

FIG. 5 and FIG. 6 show the structures of another embodiment of this invention under different work status. A pre-stage boost device for UPS, comprising:

a selector switch 130, for the selection of connecting to AC power input 110 or battery input 120;

a power factor inductor 140, one end thereof is coupled to the said selector switch 130;

a common boost circuit 150, including: closed loop coupled in sequence, a rectifier diode D1, a second switch Q2 with a second diode connected in parallel thereto, a third switch Q3 with a third diode connected in parallel thereto, and, a fourth switch Q4 with a fourth diode connected in parallel thereto;

a rectifier circuit 160, including; one end thereof is coupled to the said first node, the other end is coupled to a rectifier diode D5 of the positive output terminal of the said pre-stage boost device for UPS; on end thereof is coupled to the said first node, the other end is coupled to a rectifier diode D6 of the negative output terminal of the said pre-stage boost device for UPS; and one end is coupled to the negative output terminal of the said pre-stage boost device for UPS, the other end is coupled to a rectifier diode D4 of the cathode of the said battery input 120. The said rectifier diode D5 and rectifier diode D6 are in opposite directions in relation to the first node, and the anode of the said rectifier diode D4 and the anode of rectifier diode D6 are coupled to each other; and

a filter circuit 170, including: one end thereof is coupled to the negative output terminal of the said pre-stage boost device for UPS, the other end is coupled to a first capacitor C1 of the said grounding node; and, one end thereof is coupled to the said grounding node, the other end is coupled to a second capacitor C2 of the negative output terminal of the said pre-stage boost device for UPS.

Wherein, the said second switch Q2, third switch Q3, and fourth switch Q4 are a MOS tube respectively.

Referred to FIG. 6, DC supply from the battery input 120 is selected for the selector switch 130. The corresponding boost operation of this pre-stage boost device for UPS is achieved through the following mode.

As long as either one of the second switch Q2,third switch Q3 or the fourth switch Q4 is closed, the power factor inductor 140 is charged from the battery input 120.

When the second switch Q2, third switch Q3 and the fourth switch Q4 are all disconnected, the first capacitor C1 and the second capacitor C2 in the filter circuit 170 are charged from the battery input 120 and the power factor inductor 140.

When the third switch Q3 and fourth switch Q4 are disconnected, and the second switch Q2 is closed, the second capacitor C2 in the filter circuit 170 is charged from the battery input 120 and the power factor inductor 140.

When the second switch Q2 and fourth switch Q4 are disconnected, and the third switch Q3 is closed, the first capacitor C1 in the filer circuit 170 is charged from the battery input 120 and the power factor inductor 140.

Referred to FIG. 5, AC supply of the AC power input 110 is selected for the selector switch 130. The corresponding boost operation of this pre-stage boost device for UPS is achieved through the following mode.

During the positive AC half cycle:

As long as either the second switch Q2 or the fourth switch Q4 is closed, the power factor inductor 140 is charged from the AC power input 110.

As long as the second switch Q2 and the fourth switch Q4 are disconnected, the first capacitor C1 in the filter circuit 170 is charged from the AC power input 110 and the power factor inductor 140.

During the negative AC half cycle:

As long as the third switch Q3 is closed, the power factor inductor 140 is charged from the AC power input 110.

As long as the third switch Q3 is disconnected, the second capacitor C2 in the filter circuit 170 is charged from the AC power input 110 and the power factor inductor 140.

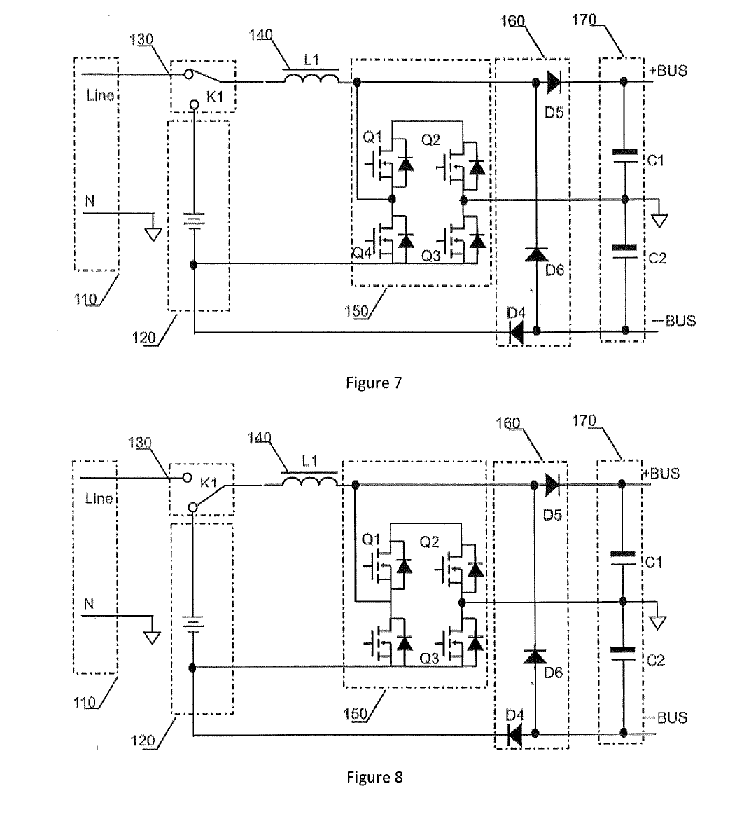

FIG. 7 and FIG. 8 show the structures of another embodiment of this invention under different work status. A pre-stage boost device for UPS, comprising:

a selector switch 130, for the selection of connecting to AC power input 110 or battery input 120;

a power factor inductor 140, one end thereof is connected to the said selector switch 130;

a common boost circuit 150, including: closed loop coupled in sequence, a first switch Q1 with a first diode connected in parallel thereto, a second switch Q2 with a second diode connected in parallel thereto, a third switch Q3 with a third diode connected in parallel thereto, and, a fourth switch Q4 with a fourth diode connected in parallel thereto;

a rectifier circuit 160, including: one end thereof is coupled to the said first node, the other end is coupled to a rectifier diode D5 of the positive output terminal of the said pre-stage boost device for UPS; one end thereof is coupled to the said first node, the other end is coupled to a rectifier diode D6 of the negative output terminal of the said pre-stage boost device for UPS; and, one end is coupled to the negative output terminal of the said pre-stage boost device for UPS, the other end is coupled to a rectifier diode D4 of the cathode of the battery input 120. The said rectifier diode D5 and rectifier diode D6 are in opposite directions in relation to the said first node, and the anode of the said rectifier diode D4 and the anode of rectifier diode D6 are coupled to each other; and

a filter circuit 170, including: one end thereof is coupled to the negative output terminal of the said pre-stage boost device for UPS, the other end is coupled to a first capacitor C1 of the said grounding node; and, one end thereof is coupled to the said grounding node, the other end is coupled to a second capacitor C2 of the negative output terminal of the said -pre-stage boost device for UPS.

Wherein, the said first switch Q1, second switch Q2, third switch Q3, and fourth switch Q4 is a MOS tube respectively.

Referred to FIG. 8, DC supply from the battery input 120 is selected for the selector switch 130. The corresponding boost operation of this pre-stage boost device for UPS is achieved through the following mode.

As long as either one of the said first switch Q1, second switch Q2, third switch Q3 or fourth switch Q4 is closed, the power factor inductor 140 is charged from the battery input 120.

When the first switch Q1, second switch Q2, third switch Q3 and fourth switch Q4 are all disconnected, the first capacitor C1 and second capacitor C2 in the filter circuit 170 are charged from the battery 120 and the power factor inductor 140.

When the third switch Q3 and the fourth switch Q4 are disconnected, the first switch Q1 and the second switch Q2 are closed, the second capacitor C2 in the filter circuit 170 is charged from the battery input 120 and the power factor inductor 140.

When the third switch Q3 is closed, the first switch Q1, second switch Q2 and fourth switch Q4 are disconnected, the first capacitor C1 in the filter circuit 170 is charged from the battery input 120 and the power factor inductor 140.

Referred to FIG. 7, AC supply from the AC power input 110 is selected for the selector switch 130. The corresponding boost operation of this pre-stage boost device for UPS is achieved through the following mode.

During the positive AC half cycle:

As long as either the second switch Q2 or the fourth switch Q4 is closed, the power factor inductor 140 is charged from the AC power input 110.

As long as the second switch Q2 and fourth switch Q4 are disconnected, the first capacitor C1 in the filter circuit 170 is charged from the AC power input 110 and the power factor inductor 140

During the negative half cycle:

As long as either the first switch Q1 or the third switch Q1 is closed, the power factor inductor 140 is charged from the AC power input 110.

As long as the first switch Q1 and the third switch Q1 are disconnected, the second capacitor C2 in the filter circuit 170 is charged from the AC power input 110 and the power factor inductor 140.

The above content is a further description to the present invention with a reference to the preferred embodiments, and it should not be considered as a limitation to the practical implementations of this invention. For any ordinary technical personnel in the technical filed to which this invention belongs, certain simple deductions and substitutions thereof can be made under presumptions not deviated from the concept of this invention. These should all be regarded as falling into the patent scope of this invention.

1. A pre-stage boost device for UPS, characterised in that, it comprises:
a selector switch (130), for the selection of connecting to AC power input (110) or battery input (120);
a power factor inductor (140), one end thereof is coupled to the said selector switch (130);
a common boost circuit (150), including: coupled in sequence, a first switch (Q1), a second switch (Q2) and a third switch (Q3);
wherein, one end of the said first switch (Q1) and the other end of the said power factor inductor (140) are coupled to a first node; one end of the said second switch (Q2) and one end of the third switch (Q3) are coupled to a grounding node; and the other end of the third switch (Q3) and the cathode of the battery input (120) are coupled to a second node;
a rectifier circuit (160), including: one end there of is coupled to the said first node, the other end is coupled to a rectifier diode (D5) of the positive output terminal of the said pre-stage boost device for UPS; one end thereof is coupled to the said first node, the other end is coupled to a rectifier diode (D6) of the negative output terminal of the said pre-stage boost device for UPS; and, one end is coupled to the negative output terminal of the said pre-stage boost device for UPS, the other end is coupled to a rectifier diode (D4) of the cathode of the said battery input (120). The said rectifier diode (D5) and rectifier diode (D6) are in opposite directions in relation to the said first node, and the anode of the said rectifier diode (D4) and the anode of the rectifier diode (D6) are coupled to each other; and
a filter circuit (170), including: one end thereof is coupled to the negative output terminal of the said pre-stage boost device for UPS, the other end is coupled to a first capacitor (C1) of the said grounding node; and, one end thereof is coupled to the said grounding node, the other end is coupled to a second capacitor (C2) of the negative output terminal of the said pre-stage boost device for UPS.

2. The said pre-stage boost device for UPS according to claim 1, it has these characteristics: a first diode is connected in parallel to the said first switch (Q1), a second diode is connected in parallel to the said second switch (Q2), and a third diode is connected in parallel to the said third switch (Q3); the said first diode and the second diode are coupled to each other in opposite directions, and the said second diode and the third diode are in opposite directions in relation to the said grounding node.

3. A pre-stage boost device for UPS, characterized in that, it comprises:
a selector switch (130), for the selection of connecting to AC power input (110) or battery input (120);
a power factor inductor (140), one end thereof is coupled to the said selector switch (130);
a common boost circuit (150), including: closed loop coupled in sequence, a rectifier diode (D2), a rectifier diode (D1), a second switch (Q2) and a third switch (Q3);
wherein, one end of the said rectifier diode (D1), one end of the said rectifier diode (D2) and the other end of the said power factor inductor (140) are both coupled to a first node; one end of the second switch (Q2) and one end of the third switch (Q3) are coupled to a grounding node; the other end of the said third switch (Q3), the other end of the rectifier diode (D2) and the cathode of the battery input (120) are coupled to a second node. The said rectifier diode (D1) and the said rectifier diode (D2) are in opposite directions in relation to the said first node;
a rectifier circuit (160), including: one end thereof is coupled to the said first node, the other end is coupled to a rectifier diode (D5) of the positive output terminal of the said pre-stage boost device for UPS; one end thereof is coupled to the said first node, the other end is coupled the a rectifier diode (D6) of the negative output terminal of the said pre-stage boost device for UPS; and, one end is coupled to the negative output terminal of the said pre-stage boost device for UPS, the other end is coupled to a rectifier diode (D4) of the cathode of the battery input (120). The said rectifier diode (D5) and rectifier diode (D6) are in opposite directions in relation to the said first node, and the anode of the said rectifier diode (D4) and the anode of the rectifier diode (D6) are coupled to each other; and
a filter circuit (170), including: one end thereof is coupled to the negative output of the said pre-stage boost device for UPS, the other end is coupled to a first capacitor (C1) of the said grounding node; and, one end thereof is coupled to the said grounding node, the other end is coupled to a second capacitor (C2) of the negative output of the said pre-stage boost device for UPS.

4. The said pre-stage boost device for UPS according to claim 3, characterized in that, a second diode is connected in parallel to the said second switch (Q2), and a third diode is connected in parallel to the said third switch (Q3). The said first diode and the rectifier diode (D1) are coupled to each other in opposite directions, and the said second diode and third diode are in opposite directions in relation to the said grounding node.

5. A pre-stage boost device for UPS, characterized in that, it comprises:
a selector switch (130), for the selection of connecting to AC power input (110) or battery input (120);
a power factor inductor (140), one end thereof is coupled to the said selector switch (130);
a common boost circuit (150), including, closed loop coupled in sequence, a rectifier diode (D1), a second switch (Q2), a third switch (Q3), and a fourth switch (Q4);
wherein, one end of the said rectifier diode (D1), one end of the said fourth switch (Q4) and the other end of the said power factor inductor (140) are all coupled to a first mode; one end of the said second switch (Q2) and one end of the third switch (Q3) are coupled to a grounding node; and
the other end of the third switch (Q3), the other end of the fourth switch (Q4) and the cathode of the battery input (120) are coupled to a second node;
a rectifier circuit (160), including: one end thereof is coupled to the said first node, the other end is coupled to a rectifier diode (D5) of the positive output terminal of the said pre-stage boost device for UPS; one end thereof is coupled to the said first node, the other end is coupled to a rectifier diode (D6) of the negative output terminal of the said pre-stage boost device for UPS; and, one end is coupled to the negative output terminal of the said pre-stage boost device for UPS, the other end is coupled to a rectifier diode (D4) of the cathode of the battery input (120). The said rectifier diode (D5) and rectifier diode (D6) are in opposite directions in relation to the said first node, and the anode of the said rectifier diode (D4) and anode of rectifier diode (D6) are coupled to each other; and
a filter circuit (170), including: one end thereof is coupled to the negative output terminal of the said pre-stage boost device for UPS, the other end is coupled to a first capacitor (C1) of the said grounding node; and, one end thereof is coupled to the said grounding node, the other end is coupled to a second capacitor (C2) of the negative output terminal of the said pre-stage boost device for UPS.

6. The said pre-stage boost device for UPS according to claim 5, characterized in that, a second diode is connected in parallel to the said second switch (Q2), a third diode is connected in parallel to the said third switch (Q3), and a fourth diode is connected in parallel to the said fourth switch (Q4). The said first diode and the rectifier diode (D1) are couple to each other in opposite directions, the said second diode and the third diode are in opposite directions in relation to the said grounding node, and the said rectifier diode (D1) and the said fourth diode are in opposite directions in relation to the said first node.

7. A pre-stage boost device for UPS, characterized in that, it comprises:
a selector switch (130), for the selection of connecting to AC power input (110) or battery input (120);
a power factor inductor (140), one end thereof is coupled to the said selector switch (130);
a common boost circuit (150), including closed loop coupled in sequence, a first switch (Q1), a second switch (Q2), a third switch (Q3), and a fourth switch (Q4);
wherein, one end of the said first switch (Q1), one end of the said fourth switch (Q4) and the other end of the said power factor inductor (140) are all coupled to a first node; one end of the said second switch (Q2) and one end of the third switch (Q3) are coupled to a grounding node; and the other end of the said third switch (Q3), the other end of the said fourth switch (Q4) and the cathode of the battery input (120) are coupled to a second node;
a rectifier circuit (160), including: one end thereof is coupled to the said first node, the other end is coupled to a rectifier diode (D5) of the positive output terminal of the said pre-stage boost device for UPS; one end thereof is coupled to the said first node, the other end is coupled to a rectifier diode (D6) of the negative output terminal of the said pre-stage boost device for UPS; and, one end is coupled to the negative output terminal of the said pre-stage boost device for UPS, the other end is coupled to a rectifier diode (D4) of the cathode of the said battery input (120). The said rectifier diode (D5) and rectifier diode (D6) are in opposite directions in relation to the said first node, and the anode of the said rectifier diode (D4) and the anode of the rectifier diode (D6) are coupled to each other; and
a filter circuit (170), including: one end thereof is coupled to the negative output terminal of the said pre-stage boost device for UPS, the other end is coupled to a first capacitor (C1) of the said grounding node; and, one end thereof is coupled to the said grounding node, the other end is coupled to a second capacitor (C2) of the negative output terminal of the said pre-stage boost device for UPS.

8. The said pre-stage boost device for UPS according to claim 7, characterized in that, a first diode is connected in parallel to the said first switch (Q1), a second diode is connected in parallel to the said second switch (Q2), a third diode is connected in parallel to the said third switch (Q3), and a fourth diode is connected in parallel to the said fourth switch (Q4). The said first diode and the said second diode are coupled to each other in opposite directions, the said second diode and the third diode are in opposite directions in relation to the said grounding node, and the said first diode and the said fourth diode are in opposite directions in relation to the said first node.
